(19) United States
(12) Patent Application Publication
(10) Pub. No.: US 2026/0322701 A1
(43) Pub. Date: Oct. 15, 2026

(54) AI/ML Based Radio Link Failure Prediction

(71) Applicant: Apple Inc., Cupertino, CA (US)

(72) Inventors: Peng Cheng, Beijing (CN); Alexander Sirotkin, Hod Hasharon (IL); Haijing Hu, Los Gatos, CA (US); Naveen Kumar R Palle Venkata, San Diego, CA (US)

(21) Appl. No.: 18/869,231

(22) PCT Filed: Nov. 30, 2023
(86) PCT No.: PCT/CN2023/135518

§ 371 Date: Nov. 25, 2024

(51) Int. Cl. H04L 41/16; H04W 76/18

(52) U.S. Cl. CPC H04L 41/16; H04W 76/18

(57) ABSTRACT

A method of performing AI based compression model performance monitoring by a UE. The method includes encoding, for transmission to a BS, a UE capability report; decoding configuration information, received from the BS, for training one or more AI based models for predicting radio link failure (RLF); encoding, for transmission to the BS, a notification message indicating to the BS, one or more conditions and availability of the one more AI based models for use by the UE; decoding, from the gNB, an activation instruction; activating the one more AI based models for predicting RLF based on the activation instruction; predicting the RLF using the one or more AI based models based on predicting a block error rate of reference signals or based on classifying a risk level of the RLF based on a plurality of inputs; and transmitting an RLF prediction report to the gNB based on the prediction.

### FIELD

Embodiments of the invention relate to wireless communications, including apparatuses, systems, and methods for user equipment (UE) side performance monitoring for artificial intelligence (AI) based radio link failure (RLF) prediction in a cellular communications network.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) has been the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. In 2015, a study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

### SUMMARY

Embodiments relate to wireless communications, and more particularly to apparatuses, systems, and methods for an apparatus of a user equipment (UE), the apparatus comprising one or more processors, coupled to a memory, configured to: encode, for transmission to base station (e.g., a base station (base station)), a UE capability report; decode configuration information, received from the base station, for training one or more artificial intelligence (AI) based models for predicting radio link failure (RLF); encode, for transmission to the base station, a notification message indicating to the base station, one or more conditions and availability of the one more AI based models for use by the UE; decode, from the base station, an activation instruction; activate the one more AI based models for predicting radio link failure (RLF) based on the activation instruction; predict the RLF using the one or more AI based models based on predicting a block error rate (BLER) of one or more reference signals or based on classifying a risk level of the RLF based on a plurality of inputs; and transmit a RLF prediction report to the base station based on the prediction.

Other embodiments relate to an apparatus of a base station (e.g., base station (base station)), the apparatus comprising one or more processors, coupled to a memory, configured to: decode a user equipment (UE) capability report received from a UE; encode, for transmission to the UE, configuration information, for training one or more artificial intelligence (AI) based models for predicting radio link failure (RLF); decode a notification message, received from the UE, indicating to the base station one or more conditions and availability of the one more AI based models for use by the UE; encode, for transmission to the UE, an activation instruction to indicated to the UE to activate the one more AI based models for predicting radio link failure (RLF) based on the activation instruction and predicting the RLF using the one or more AI based models based on predicting a block error rate (BLER) of one or more reference signals or based on classifying a risk level of the RLF based on a plurality of inputs; and decode, a RLF prediction report, received from the UE, based on the prediction.

The techniques described herein may be implemented in and/or used with a number of different types of devices, including but not limited to unmanned aerial vehicles (UAVs), unmanned aerial controllers (UACs), base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6 illustrates an example of a baseband processor architecture for a UE, according to some embodiments.

FIG. 7 illustrates an example block diagram of an interface of baseband circuitry according to some embodiments.

FIG. 8 illustrates an example of a control plane protocol stack in accordance with some embodiments.

FIGS. 9A and 9B illustrate example diagrams of a performing AI/ML based radio link failure (RLF) prediction and reporting the prediction output to the network according to some embodiments.

FIG. 10 illustrates an example timing diagram signaling between a user equipment (UE) and base station (e.g., a base station (base station)) for providing artificial intelligence (AI) based radio link failure (RLF) prediction according to some embodiments.

FIGS. 11A and 11B illustrate example diagrams of a base station utilizing the UE's BLER predictions to determine whether to handover the UE to another cell before radio link failure occurs according to some embodiments.

FIGS. 12A and 12B illustrate example diagrams using an artificial intelligence (AI) model at the UE to predict radio link failure based on multiple input parameters related to radio link conditions according to some embodiments.

FIG. 13 illustrates an example flow chart of a method of providing artificial intelligence (AI) based radio link failure (RLF) prediction at a user equipment (UE), according to some embodiments.

FIG. 14 illustrates an example flow chart of a method of assisting with artificial intelligence (AI) based radio link failure (RLF) prediction for user equipment (UE), at base station, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. 5G NR can support scalable channel bandwidths from 5 MHz to 100 MHz in Frequency Range 1 (FR1) and up to 400 MHz in FR2. In other radio access technologies, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately-refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

The example embodiments may be further understood with reference to the following description and the related appended drawings, wherein like elements are provided with the same reference numerals. The example embodiments relate to UE side performance monitoring for artificial intelligence (AI) based channel state information (CSI) compression model.

The example embodiments are described with regard to communication between a base station and a user equipment (UE). However, reference to a base station or a UE is merely provided for illustrative purposes. The example embodiments may be utilized with any electronic component that may establish a connection to a network and is configured with the hardware, software, and/or firmware to support UE side performance monitoring for AI based CSI compression model. Therefore, the base station or UE as described herein is used to represent any appropriate type of electronic component.

The example embodiments are also described with regard to a fifth generation (5G) New Radio (NR) network that may configure a UE to control the UE side performance monitoring. However, reference to a 5G NR network is merely provided for illustrative purposes. The example embodiments may be utilized with any appropriate type of network.

As described through the example embodiments, one limitation of existing radio link failure (RLF) determination procedures in 5G NR networks is that they take a reactive approach based on standalone assessment of reference signal block error rates, random access channel events, and radio link control status. By leveraging artificial intelligence and machine learning (AI/ML) models, multiple radio link factors can be concurrently analyzed to uncover complex correlations signifying upcoming outages. In one embodiment, a user equipment (UE), comprising one or more processors, coupled to a memory, may be configured to: encode, for transmission to a base station, a UE capability report; decode configuration information, received from the base station, for training one or more artificial intelligence (AI) based models for predicting radio link failure (RLF); encode, for transmission to the base station, a notification message indicating to the base station, one or more conditions and availability of the one more AI based models for use by the UE; decode, from the base station, an activation instruction; activate the one more AI based models for predicting radio link failure (RLF) based on the activation instruction; predict the RLF using the one or more AI based models based on predicting a block error rate (BLER) of one or more reference signals or based on classifying a risk level of the RLF based on a plurality of inputs; and transmit a RLF prediction report to the base station based on the prediction.

Throughout this description various information elements (IEs) are referred to by specific names. It should be understood that these names are only examples and the IEs carrying the information referred to throughout this description may be referred to by other names by various entities.

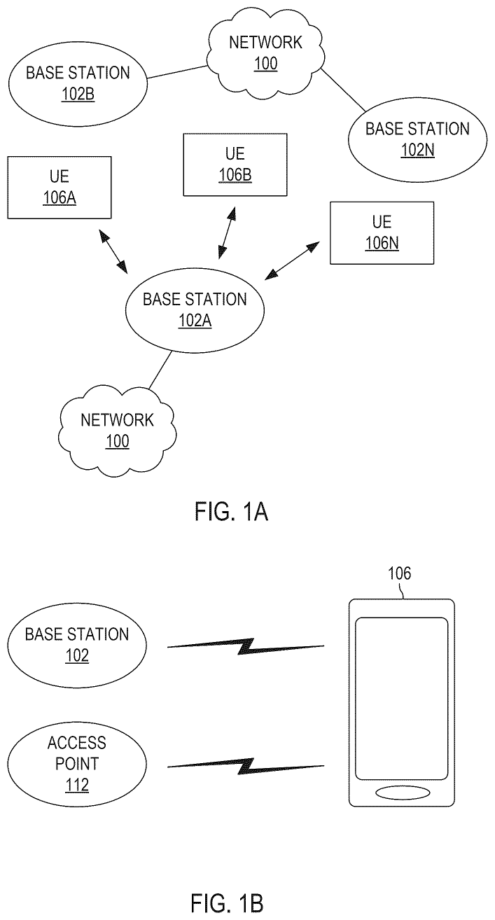

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, also referred to as the Evolved Universal Terrestrial Radio Access Network (E-UTRAN, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1A, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”. In some embodiments, a base station may be connected to a legacy evolved packet core (EPC) network and/or to a NR core (NRC) network. In addition, a base station cell may include one or more transition and reception points (TRPs). In addition, a UE capable of operating according to 5G NR may be connected to one or more TRPs within one or more base stations.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either LTE or 5G NR (or LTE or 1xRTT or LTE or GSM), and separate radios for communicating using each of Wi-Fi and Bluetooth. Other configurations are also possible.

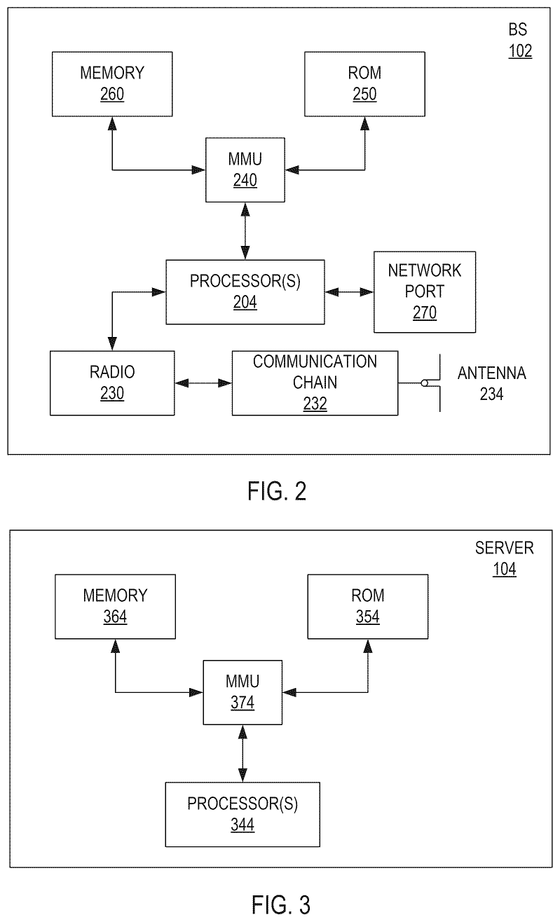

### FIG. 2: Block Diagram of a Base Station

FIG. 2 illustrates an example block diagram of a base station 102, according to some embodiments. It is noted that the base station of FIG. 2 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1a, 1b and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more base stations.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

In some embodiments, the base station or base station 102, and/or processors 204 thereof, can be capable of and configured to encode, for transmission to a base station, a UE capability report; decode configuration information, received from the base station, for training one or more artificial intelligence (AI) based models for predicting radio link failure (RLF); encode, for transmission to the base station, a notification message indicating to the base station, one or more conditions and availability of the one more AI based models for use by the UE; decode, from the base station, an activation instruction; activate the one more AI based models for predicting radio link failure (RLF) based on the activation instruction; predict the RLF using the one or more AI based models based on predicting a block error rate (BLER) of one or more reference signals or based on classifying a risk level of the RLF based on a plurality of inputs; and transmit a RLF prediction report to the base station based on the prediction.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, and UE devices 106 access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

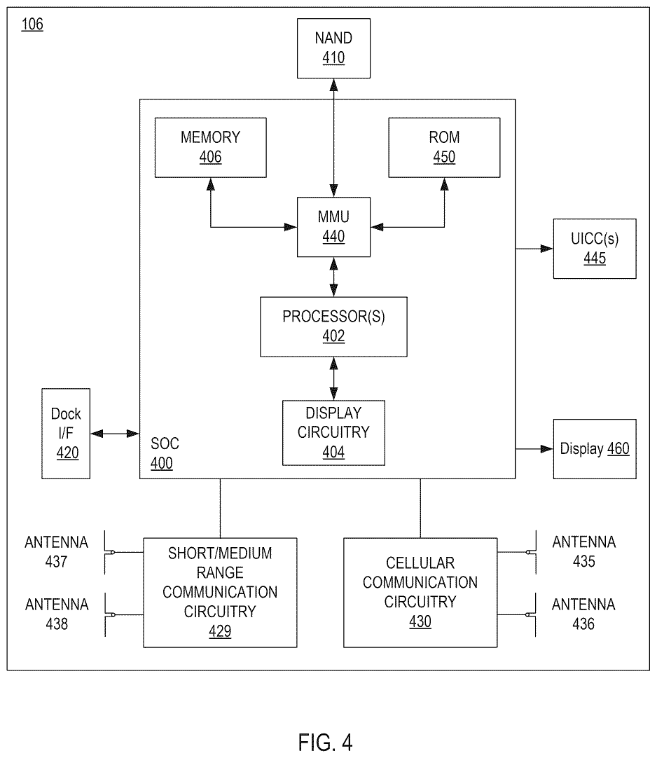

### FIG. 4: Block Diagram of a User Equipment

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. Dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMS may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 supports a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VoLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

In some embodiments, the base station 102 and/or the processors 402 thereof can be configured to and/or capable of selecting, at the base station, a dynamic measurement opportunity sharing scheme for L3 measurement opportunities relative to L1 measurement opportunities, as described herein.

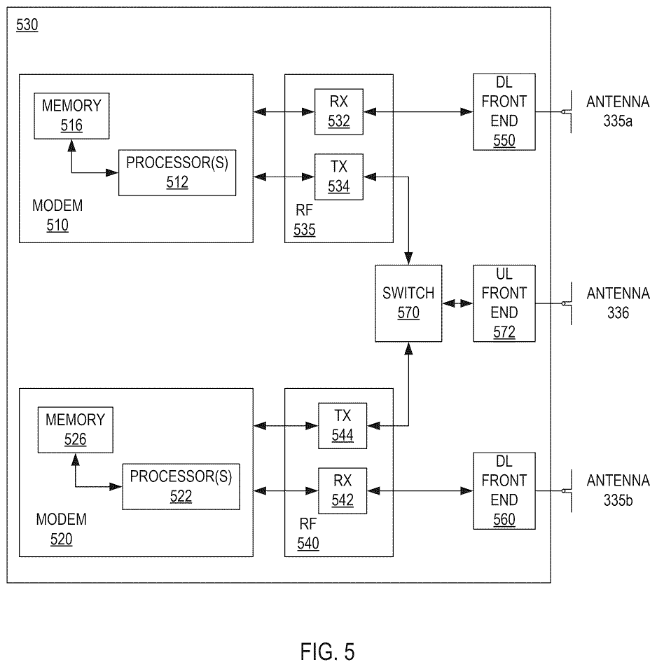

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. Dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 535. RF front end 535 may include circuitry for transmitting and receiving radio signals. For example, RF front end 535 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 535, 550, 570, 572, 335a, 335b, and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335a, 335b, and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

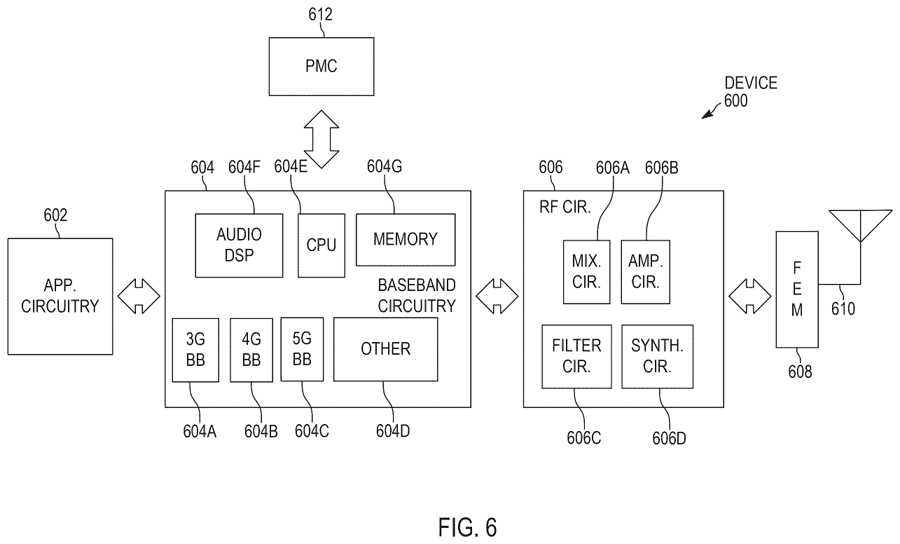

### FIG. 6: Block Diagram of a Baseband Processor Architecture for a UE

FIG. 6 illustrates example components of a device 600 in accordance with some embodiments. It is noted that the device of FIG. 6 is merely one example of a possible system, and that features of this disclosure may be implemented in any of various UEs, as desired.

In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE 106 or a RAN node 102A. In some embodiments, the device 600 may include less elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuity 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), sixth generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 604G and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a necessity. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 606a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals, and the input baseband signals may be analog baseband signals, although the scope of the embodiments is not limited in this respect. In some alternate embodiments, the output baseband signals, and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a necessity. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

While FIG. 6 shows the PMC 612 coupled only with the baseband circuitry 604, in other embodiments the PMC 612 may be additionally or alternatively coupled with, and perform similar power management operations for, other components such as, but not limited to, application circuitry 602, RF circuitry 606, or FEM 608.

In some embodiments, the PMC 612 may control, or otherwise be part of, various power saving mechanisms of the device 600. For example, if the device 600 is in a radio resource control_Connected (RRC_Connected) state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC_Idle state, where it disconnects from the network and does not perform operations such as channel quality feedback, handover, etc. The device 600 goes into a very low power state and it performs paging where again it periodically wakes up to listen to the network and then powers down again. The device 600 may not receive data in this state, in order to receive data, it will transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used execute Layer 3, Layer 2, or Layer 1 functionality, while processors of the application circuitry 604 may utilize data (e.g., packet data) received from these layers and further execute Layer 4 functionality (e.g., transmission communication protocol (TCP) and user datagram protocol (UDP) layers). As referred to herein, Layer 3 (L3) may comprise a radio resource control (RRC) layer, described in further detail below. As referred to herein, Layer 2 (L2) may comprise a medium access control (MAC) layer, a radio link control (RLC) layer, and a packet data convergence protocol (PDCP) layer, described in further detail below. As referred to herein, Layer 1 (L1) may comprise a physical (PHY) layer of a UE/RAN node, described in further detail below. Accordingly, the baseband circuitry 604 can be used to encode a message for transmission between a UE and a base station, or decode a message received between a UE and a base station.

For example, the baseband circuitry 604, working in conjunction with the application circuitry 602, Radio Frequency (RF) circuitry 606, front-end module (FEM) circuitry 608, one or more antennas 610, and power management circuitry (PMC) 612 can be used to receive, from a base station, an indication to activate artificial intelligence (AI) based compression model performance monitoring at the UE; decode, at the UE, configuration information for the AI based compression model performance monitoring received from the base station. In another embodiment, the baseband circuitry 604 can be used to decode channel state information (CSI) received from the base station; compress the CSI, at the UE, using an AI based compression model to generate a compressed CSI; reconstruct the compressed CSI at the UE using an AI based reconstruction model to generate the reconstructed CSI for the AI based compression model monitoring. In another embodiment, the baseband circuitry 604 can be used to determine a similarity metric between the CSI and the reconstructed CSI and/or compare the similarity metric to a compression model threshold; and transmit a monitoring report to the base station based on the comparison. These examples are not intended to be limiting. The baseband circuitry can be used as previously described.

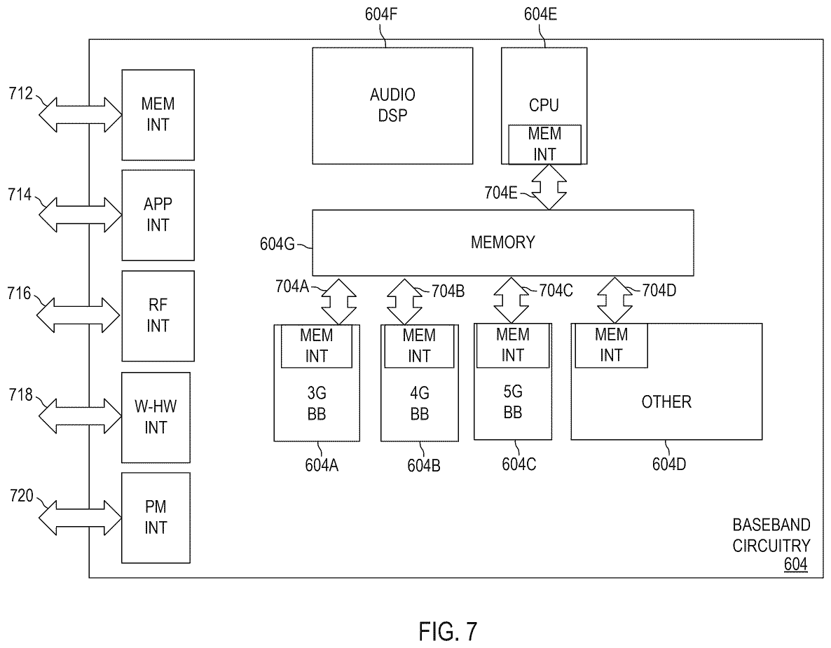

### FIG. 7: Block Diagram of an Interface of Baseband Circuitry

FIG. 7 illustrates example interfaces of baseband circuitry in accordance with some embodiments. It is noted that the baseband circuitry of FIG. 7 is merely one example of a possible circuitry, and that features of this disclosure may be implemented in any of various systems, as desired.

As discussed above, the baseband circuitry 604 of FIG. 6 may comprise processors 604A-604E and a memory 604G utilized by said processors. Each of the processors 604A-604E may include a memory interface, 704A-704E, respectively, to send/receive data to/from the memory 604G.

The baseband circuitry 604 may further include one or more interfaces to communicatively couple to other circuitries/devices, such as a memory interface 712 (e.g., an interface to send/receive data to/from memory external to the baseband circuitry 604), an application circuitry interface 714 (e.g., an interface to send/receive data to/from the application circuitry 602 of FIG. 6), an RF circuitry interface 716 (e.g., an interface to send/receive data to/from RF circuitry 606 of FIG. 6), a wireless hardware connectivity interface 718 (e.g., an interface to send/receive data to/from Near Field Communication (NFC) components, Bluetooth® components (e.g., Bluetooth® Low Energy), Wi-Fi® components, and other communication components), and a power management interface 720 (e.g., an interface to send/receive power or control signals to/from the PMC 612.

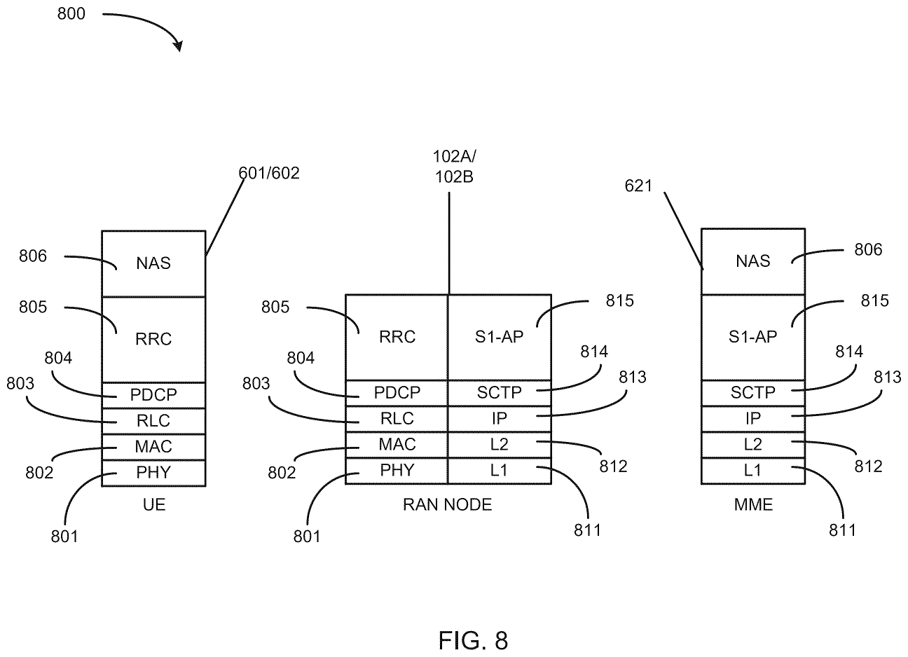

### FIG. 8: Control Plane Protocol Stack

FIG. 8 is an illustration of a control plane protocol stack in accordance with some embodiments. In this embodiment, a control plane 800 is shown as a communications protocol stack between the UE 106a (or alternatively, the UE 106b), the RAN node 102A (or alternatively, the RAN node 102B), and the mobility management entity (MME) 621.

The PHY layer 801 may transmit or receive information used by the MAC layer 802 over one or more air interfaces. The PHY layer 801 may further perform link adaptation or adaptive modulation and coding (AMC), power control, cell search (e.g., for initial synchronization and handover purposes), and other measurements used by higher layers, such as the RRC layer 805. The PHY layer 801 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 802 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 803 may operate in a plurality of modes of operation, including: Transparent Mode (TM), Unacknowledged Mode (UM), and Acknowledged Mode (AM). The RLC layer 803 may execute transfer of upper layer protocol data units (PDUs), error correction through automatic repeat request (ARQ) for AM data transfers, and concatenation, segmentation and reassembly of RLC SDUs for UM and AM data transfers. The RLC layer 803 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 804 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 805 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 601 and the RAN node 102A may utilize a Uu interface (e.g., an LTE-Uu interface) to exchange control plane data via a protocol stack comprising the PHY layer 801, the MAC layer 802, the RLC layer 803, the PDCP layer 804, and the RRC layer 805.

The non-access stratum (NAS) protocols 806 form the highest stratum of the control plane between the UE 601 and the MME 621. The NAS protocols 806 support the mobility of the UE 601 and the session management procedures to establish and maintain IP connectivity between the UE 601 and the P-GW 623.

The S1 Application Protocol (S1-AP) layer 815 may support the functions of the S1 interface and comprise Elementary Procedures (EPs). An EP is a unit of interaction between the RAN node 102A and the CN 1020. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) 814 may ensure reliable delivery of signaling messages between the RAN node 102A and the MME 621 based, in part, on the IP protocol, supported by the IP layer 813. The L2 layer 812 and the L1 layer 811 may refer to communication links (e.g., wired or wireless) used by the RAN node and the MME to exchange information.

The RAN node 102A and the MME 621 may utilize an S1-MME interface to exchange control plane data via a protocol stack comprising the L1 layer 811, the L2 layer 812, the IP layer 813, the SCTP layer 814, and the S1-AP layer 815.

Wireless communication systems provide mobility by enabling user equipment (UEs) to move between cells via a process referred to as handover. Handover occurs when a mobile UE switches from one cell to another neighboring cell. Mechanisms have been established to help ensure a smooth transition between cells. NR supports different types of handover that were not supported in the previous 4G LTE specification. The basic handover in NR has been based on LTE handover mechanisms in which the network controls UE mobility based on UE measurement reporting. This measurement reporting typically involves Layer 3 (L3) measurements of neighbor cells and reporting from the UE to the eNB.

It should be noted that 5G NR enables various advanced capabilities as compared to LTE, and one existing procedure that can benefit from enhancement leveraging these 5G technologies is the radio link failure (RLF) mechanism. RLF refers to cases where the radio link quality deteriorates below certain thresholds such that communication between a user equipment (UE) and serving base station is disrupted. The current RLF procedure has some limitations in that it reacts to failures only after they have already occurred, rather than proactively avoiding them. The procedure also relies on a limited set of reference signal measurements that may not fully capture emerging radio link problems. Additionally, downlink signals and uplink signals are assessed independently even though they are often correlated in indicating radio link conditions.

These gaps present use cases where advanced algorithms like artificial intelligence (AI) and machine learning (ML), coupled with coordination between the UE and next generation NodeB (base station), can provide more predictive identification of risk of impending radio link failures. By intelligently fusing multiple radio link indicators and historical measurements, failures can potentially be predicted ahead of time using AI/ML, allowing mitigating actions like handovers to prevent deterioration rather than simply reacting to RLF events. Enabling such predictive failure management can further improve reliability mechanisms as 5G networks continue to advance.

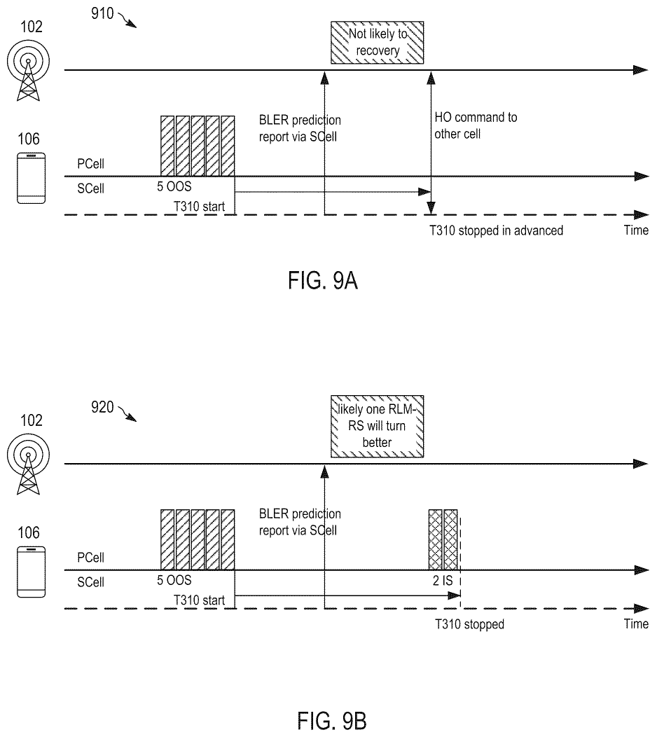

### FIGS. 9A, 9B: AI/ML Based Radio Link Failure (RLF) Prediction and Reporting

In cellular systems, radio link monitoring involves consistently measuring reference signals to detect when the radio link quality drops below expected thresholds. When the radio link quality drops below the expected thresholds, there is a significant chance of radio link failure (RLF) occurring, in which the radio link between two devices fails to function within desired parameters. When RLF is declared based on thresholds set by the network, communication can be disrupted until the link can be re-established.

However, current RLF procedures in 5G NR have some key problems, including being passive instead of proactively avoiding failures, relying on a limited set of reference signals for radio link monitoring, which may not fully capture emerging issues, using static trigger conditions that are decoupled between downlink and uplink indicators, and incurring significant costs like re-establishment when failure is declared.

To overcome these challenges, embodiments provided herein enable UE-side monitoring and reporting of AI-based CSI compression model performance. This is achieved by providing CSI reconstruction capabilities at the UE using an AI-based reconstruction model that can be used to predict block error rates (BLER). The original CSI, prior to compression, can then be compared to the reconstructed CSI at the UE side using intermediate metrics like squared generalized cosine similarity (SGCS). Defined monitoring procedures allow evaluation of compression model quality over periodic windows based on thresholding the intermediate metric. Network configuration of parameters such as an evaluation monitoring window, thresholds, etc. allows flexible supervision. By determining CSI reconstruction and intermediate metric monitoring procedures performed at the UE, issues with the AI compression model can be localized and reported to the network rapidly. The solutions improve reliability of AI-based CSI compression deployments.

FIGS. 9A and 9B illustrate example diagrams of a performing AI/ML based radio link failure (RLF) prediction and reporting the prediction output to the network according to some embodiments. As depicted, FIG. 9A-B illustrates a UE collecting various radio link inputs such as, for example, reference signal received power (RSRP), reference signal received quality (RSRQ), downlink throughput, and beam index. These inputs are fed into a BLER prediction model comprising a trained machine learning model that generates predicted future BLER and a confidence level associated with the BLER prediction. The confidence level and BLER waveform depicting the predicted rise in BLER over a future duration are transmitted from the UE to the next generation NodeB (base station). By forecasting potential deterioration in BLER, the base station can proactively provide assistance to the UE to avoid radio link failure, for example by triggering early handover to another cell based on the BLER predictions.

More specifically, in diagram 910 of FIG. 9A, the primary cell (PCell) serving the user equipment (UE) detects 5 consecutive out-of-sync (OOS) indications, triggering a T310 RLF timer. A secondary cell (SCell) receives a BLER prediction report from the UE indicating the radio conditions are not likely to recover on the PCell. Before T310 expires, the SCell sends a handover (HO) command to the PCell and/or the network (e.g., base station) move the UE to another cell.

In the diagram 920 of FIG. 9B, the PCell serving the UE initially has 5OOS indications, starts the T310 timer, but subsequently receives 2 in-sync (IS) indications showing potential recovery. The SCell receives the BLER prediction report which allows the network to refrain from handover, and T310 is stopped at the PCell based on radio link recovery. By predicting BLER trends via machine learning, the reliability of mobility procedures can be enhanced based on coordination between UE and base station across primary and secondary cells.

Thus, the embodiments described herein, use AI/ML based block error rate (BLER) forecasting operations implemented in the user equipment (UE) to predict potential deterioration in radio link quality, and coordinate with a network via secondary cells to leverage the BLER predictions for making adaptive decisions on mobility procedures to prevent radio link failures.

In one embodiment, the UE predicts one or more BLERs indicating risk of future RLF events providing a proactive approach for RLF procedures rather than reacting to problems passively via existing RLF procedures. The predicted BLER levels allow activating alternative procedures such as, for example, using early handovers proactively. Reporting predictions over the secondary cell and adapting procedures based on the BLER forecasts enables reliable coordination between the UE and base station to act in advance of an RLF.

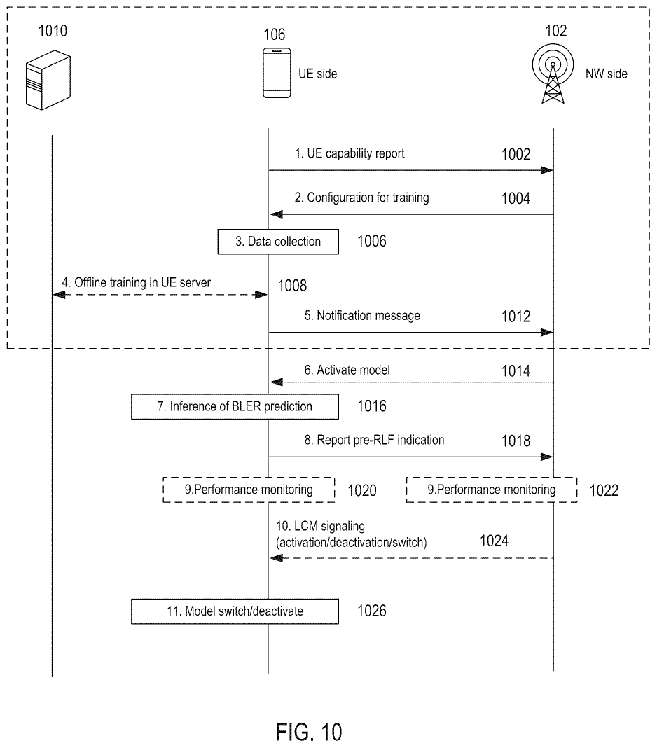

### FIG. 10: Timing Diagram for AI/ML Based Radio Link Failure (RLF) Prediction and Reporting

FIG. 10 illustrates an example timing diagram signaling between a user equipment (UE) and base station (base station) for providing artificial intelligence (AI) based radio link failure (RLF) prediction according to some embodiments. Also, FIG. 10 provides an example illustration of a UE 106 communicating with a base station 102 (e.g., a base station). In various embodiments, some of the signaling shown may be performed concurrently, in a different order than shown, or may be omitted. Additional signaling may also be performed as desired. As shown, this signaling may flow as follows as one example embodiment. The signaling shown in FIG. 10 may be used in conjunction with any of the systems, methods, and/or devices. In various embodiments, some of the signaling shown may be performed concurrently, in a different order than shown, or may be omitted. Additional signaling may also be performed as desired. As shown, this signaling may flow as follows as one example embodiment.

The signaling may begin with a UE, such as UE 106, transmitting 1002, to a base station (e.g., a base station 102), a UE capability report. The UE capability report can indicate support for temporal prediction of block error rate (BLER) of a reference signal for radio link monitoring (RLM), support prediction of cross RLM-RS BLER (e.g., predicting the BLER of one RLM-RS based on BLER measurements of a different RLM-RS rather than directly measuring each RLM-RS), a maximum number of history samples and predicted samples for BLER prediction, a maximum number of predicted samples, and a maximum number of parallel predictions. It should be noted that RLM-RS can be specific reference signals (e.g. CSI-RS, SSB) that are configured for directly monitoring the radio link quality.

The signaling may also include the base station, such as base station 102, providing 1004 configuration information to the UE for training one or more artificial intelligence (AI) based models for predicting radio link failure (RLF). The signaling may also include the UE collecting 1006 data for training the one or more AI based models. In one embodiment, the configuration information can include an indication of each type of the one more AI based models (e.g., Long Short-Term Memory (LSTM) or Recurrent Neural Network (Rnn), a prediction window length for BLER prediction, and a number of parallel predictions.

The signaling may also include the UE communicating the data collection 1006 to an offline server 1010 for offline training 1008 the one or more AI based models using data collected at the UE.

The signaling may also include the UE sending 1012 a notification message indicating to the base station one or more conditions and availability of the one more AI based models for use by the UE.

The signaling may include the base station sending 1014 an activation instruction (e.g., sending the activation instruction via downlink control information (DCI), medium access control channel element (MAC-CE) or radio resource control (RRC) signaling) to the UE to activate the one more AI based models at the UE 106 for predicting radio link failure (RLF) based on the activation instruction. The signaling may include may predicting 1016 of the RLF using the one or more AI based models based on predicting a block error rate (BLER) (e.g. inference of BLER prediction) of one or more reference signals or based on classifying a risk level of the RLF based on a plurality of inputs.

The signaling may include the UE sending 1018 to the base station a pre-RLF indication report, which may be based on the predictions. The signaling may include the UE monitoring 1020 performance of the one or more AI based models. Also, the signaling may include the base station monitoring 1022 performance of the one or more AI based models.

The signaling may include the base station signaling 1024 to the UE AI model lifecycle management (e.g., LCM signaling) to deactivate, activate, and/or switch the one or more AI based models based on the performance monitoring. The signaling may include the UE deactivating and/or switching the one or more AI based models.

Thus, as described in FIG. 10, the UE first transmits a capability report to the base station indicating supported features for the RLF prediction, including types of predictions modes, maximum history lengths, etc. After capability reporting, the base station sends configuration information for training AI based models at the UE tailored to the reported capabilities. The UE collects data, trains the AI based models, either at the UE or remotely, and sends a notification message to inform the base station about available trained AI based models at the UE and their applicability conditions. Based on this notification, the base station determines and signals appropriate AI model activation and configuration settings to the UE. According to the activation and configuration instructions, the UE performs RLF inference via the trained AI based models, generating RLF predictions that indicate potential upcoming RLF events. The UE can report these early predictions to the base station. Additionally, the UE and/or base station can monitor the activated AI model's performance over time based on metrics such as, for example, error rate or system efficiency, and initiating AI model switching or deactivation as needed based on the evaluation results. By leveraging the trained AI based models and coordination signaling between the UE and base station, radio link conditions can be reliably predicted ahead of time and mitigating actions can be proactively applied to avoid communication failures. In addition, significant overhead at the base station and network can be avoided by reducing the actual handover failures that can occur without the use of the process illustrated in FIG. 10.

It should be noted that the UE can be configured to perform a variety of combinations of various alternatives for the BLER predictions. In some embodiments, the UE can be configured by the network to perform various block error rate (BLER) prediction alternatives leveraging machine learning models including temporal BLER prediction, cross-reference signal BLER prediction, and hybrid combinations thereof.

In one example, using the temporal BLER Prediction, the UE can predict future BLER values of a configured radio link monitoring RS (RLM-RS) based on past measurements of that same RLM-RS over a configured time window. The number of previous (history) and predicted samples can be set by the network. This supports both explicit RLM-RS configurations as well as implicit prediction based on Transmission Configuration Indicator (TCI) states of activated physical downlink control channel (PDCCH).

In another example, using the cross-RS BLER Prediction, the UE can predict the BLER trends of one RLM-RS based on historically measured BLER of a different RLM-RS or other reference signal (e.g., SSB/CSI-RS not configured as RLM-RS). Using the predicted future BLER trends based on different RLM-RS can reduce a UE's measurement efforts and assist in covering all possible beam spatial directions to alleviate limitations that a maximum number of RLM-RS is small. This leverages long-term beam/spatial correlations across signals provided by the network.

In a further example, using the hybrid model, the UE can be configured to combine the temporal BLER and the cross-RS BLER prediction models for improved accuracy. Further supplemental measurements can enhance predictions. For each of the BLER predication model alternatives, associated confidence levels, which can be indicative of estimation accuracy, can be configured and provided to be reported with each BLER prediction.

It should also be noted that the UE can be configured for when to perform the BLER prediction. That is, the UE can perform the BLER prediction and reporting in various modes including continuous, periodic, and event-triggered to balance performance and power efficiency. Other measurement quantities (e.g. Cell layer 3 (L3) measurement, layer 1 (L1) RSRP of the RS) can also be used as assistance information and/or AI/ML input.

For continuous operation, the UE can start prediction upon reception of configuration information until a timer expiry. In one example, the UE perpetually predicts and reports BLER after initial configuration until expiry of a network-defined timer.

For Periodic BLER prediction, the UE is configured with another periodicity for predicted BLER measurement. For example, the Periodic BLER prediction can occur at a regular interval also configured by the network.

For event-triggered prediction, the network specifies trigger conditions to enable more power efficient non-continuous operation, while still activating BLER forecasts when radio conditions deteriorate. Potential triggers include expiry of the RLF risk timer T, BLER of all or a subset of radio link monitoring RSs (RLM-RSs) exceeding thresholds, detection of consecutive out-of-sync indications from lower layers, and combinations thereof.

For event-triggered operation, the network specifies trigger conditions to activate BLER prediction, such as, for example: event 1) when a timer (T) for radio link failure risk is triggered (e.g. T310), event 2) a BLER of all configured radio link monitoring RSs (RLM-RSs) exceeds a threshold, event 3) a BLER of any one or more RS in a configured RS set falls below a threshold, event 4) a BLER of a subset (M) of RLM-RSs exceeding a threshold (e.g., M<N, where N is a constant, such as N310 defined in the 3GPP specification as a maximum number of consecutive “out-of-sync” indications for the PCell received from lower layers), and/or event 5) detecting at least M consecutive out-of-sync (OOS) indications from lower layers. M can be configured by lower layer communication.

It should be noted that event 1 can also be configured together with event 2, 3, and 4 (i.e., when reporting is triggered when both event 1 and event 2, or when both event 1 and event 3 are satisfied. For event 3 and event 4, the UE can be configured whether only RS(s) in configured RLM-RS set, or another configured RS set. Thus, the network can further configure combinational triggers (e.g. event 1 and event 2) for prediction activation, along with whether dedicated RLM-RSs or other RS sets apply. By supporting such adaptive BLER prediction activation schemes, efficiency and reliability of radio link failure mechanisms can be enhanced.

Also, it should also be noted that the UE can be configured for reporting the pre-RLF indication (e.g., RLF prediction report). For example, the UE can report BLER predictions and RLF predictions to a network over primary and secondary cells using various modes including periodic, event-triggered, event-triggered periodic, and combinations thereof.

For period predictions, RLF predications can be transmitted to the primary cell over radio resource control (RRC) signaling whereas event-triggered reports leverage a secondary cell using new dedicated RRC or media access control (MAC) control elements when events such as, for example, BLER thresholds are achieved.

For event-triggered reporting, the UE can report the RLF prediction report based on a first scenario and a second scenario. In the first scenario, the UE can report the RLF prediction to the primary cell via RRC when an event (e.g., event 3) occurs.

In the second scenario, the UE can report the RLF prediction to an available secondary cell via new MAC control element or RRC when events such as, for example, events 1, 2, 4 or 5 occur, since primary cell uplink may be compromised.

For the first scenario and the second scenario, a scheduling request (SR) can also be associated with reporting events (e.g., event triggers) to indicate presence of a report, using either a common SR for both scenarios and separate SR resources depending on the event.

It should be noted that the network upon reception of the SR if, for example, in scenario 1, the RLF prediction report is reported, and primary cell recovery is expected, and the network may wait for the radio link to recover. Further, transmission over secondary cells helps ensure reliable reception of warnings even if the primary cell uplink fails.

For example, the UE can report the RLF prediction to one or more secondary cells via a new UL MAC-CE or RRC (e.g., similar to events 1 or event 2 reporting). Hence, supporting adaptive reporting modes and channels facilitates timely handovers or other remediation actions by the network to avoid communication failures based on predicted BLER trends.

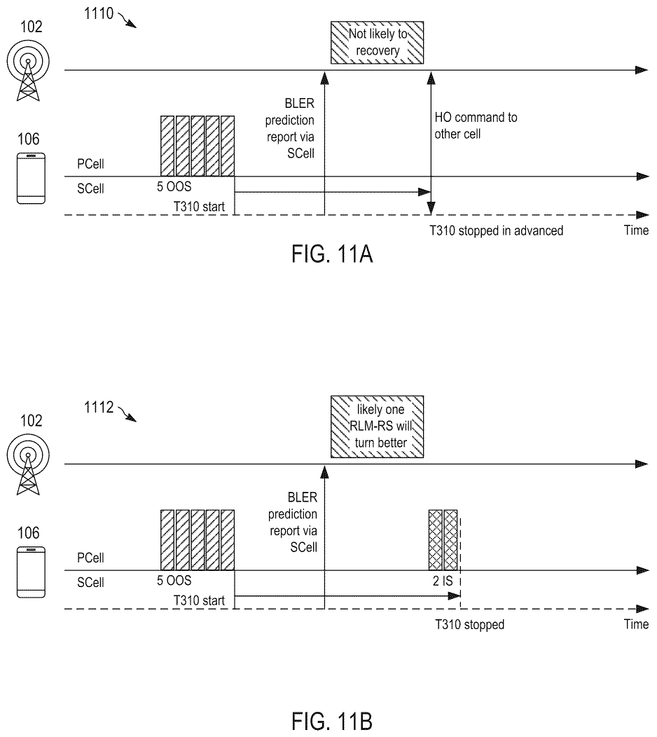

### FIGS. 11A, 11B: AI/ML Based Radio Link Failure (RLF) Prediction and Handover

FIGS. 11A and 11B illustrate example diagrams of a base station such as, for example, base station 106, utilizing the UE's BLER predictions to determine whether to handover the UE, such as, for example UE 106, to another cell before radio link failure occurs according to some embodiments.

As depicted in FIG. 11A, in the upper diagram 1110, depicts a conventional scenario where the primary cell experiences 5 out-of-sync (OOS) indications, starting the RLF risk timer T310. Since BLER predictions are not utilized, T310 expires leading to RLF declaration before any preventive action occurs. This forces the UE to perform cell selection and complete RRC re-establishment to recover connectivity.

In contrast, in FIG. 11B, the lower diagram 1112 illustrates the RLF avoidance enhancement enabled by artificial intelligence based BLER prediction. Initially, the primary cell serving the UE 102 suffers 5 consecutive out-of-sync (OOS) indications, meeting the defined trigger threshold that starts the RLF risk timer T310.

However, in the enhanced mode, the UE 102 leverages the trained BLER prediction model to forecast upcoming radio link conditions, generating a predicted BLER for the primary cell. A BLER prediction report is transmitted via an available secondary cell, indicating the UE 102 is not likely (e.g., less than a defined percentage, threshold, or assigned value) to recover based on the projected BLER.

The secondary cell can receive and analyze the BLER prediction report and proactively act ahead of the predicted RLF. For example, the primary cell, or the secondary cell if the primary cell connection is poor, can preemptively send a handover command (HO) to the PCell and/or base station 106 so as to move the UE 102 to an alternative cell. Accordingly, the handover prevents expiry of T310 at the primary cell, proactively avoiding the RLF event and preserving continuity of operation.

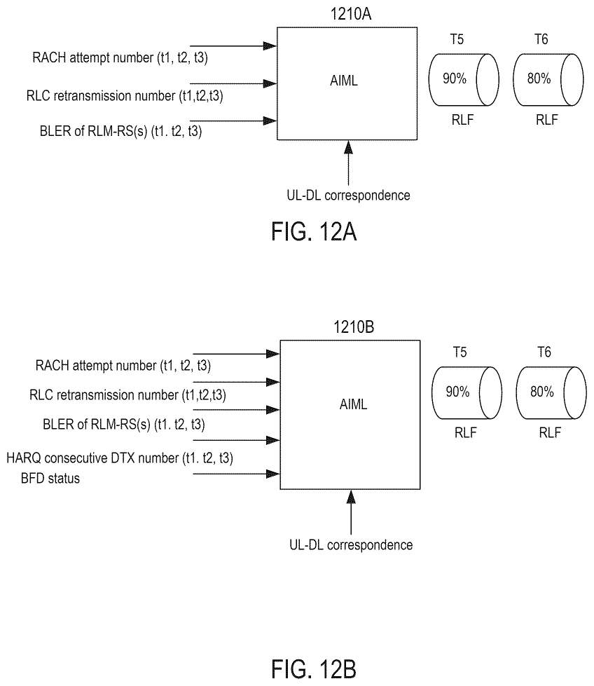

### FIGS. 12A, 12B: AI/ML Based Radio Link Failure (RLF) Prediction and Reporting

FIGS. 12A and 12B illustrate examples of diagram using an artificial intelligence (AI) model at the UE to predict radio link failure based on multiple input parameters related to radio link conditions in accordance with some embodiments.

In one embodiment, the UE can use an alternative AI/ML RLF prediction operation to determine RLF and a risk classification score and/or confidence level for an upcoming RLF event based on analysis of multiple radio link condition inputs. These inputs can include, for example, random access channel (RACH) attempt metrics; radio link control (RLC) retransmission metrics; and block error rates (BLER) of reference signals for radio link monitoring (RLM), and/or other defined metrics (e.g., uplink (UL)/downlink (DL) channel fading, and system throughputs and hybrid automatic repeater request discontinuous transmission (HARQ DTX) status).

The alternative AI/ML RLF prediction operation uses a user equipment (UE) side AI based model for inference of RLF risks based on fusing the existing indicator metrics as well multiple supplemental radio link metrics as model inputs. The alternative AI/ML RLF prediction operation can include one or more alternatives (e.g., two alternatives) that include a first alternative, which uses the existing three RLM, RACH, and RLC metrics along with uplink-downlink (UL/DL) channel correspondence as model inputs.

The second alternative expands upon this by further incorporating the additional metrics such as, for example, HARQ indicators and reference signal measured power into the model for enhanced RLF risk identification. By applying AI/ML techniques to concurrently analyze multiple correlated factors indicative of radio link conditions, compared to legacy standalone assessment, more accurate and timely predictions of potential upcoming failures can be achieved. This enables appropriate preemptive actions to avert communication losses.

As illustrated in FIG. 12A, diagram 1210A depicts the first alterative, where the artificial intelligence/machine learning (AI/ML) model for radio link failure (RLF) prediction leverages the existing radio link metrics considered in legacy RLF determination as model inputs (which may also include time of inputs such as, for example, t1, t2, t3, etc.). These include random access channel (RACH) attempt numbers, radio link control (RLC) retransmission numbers, and BLER of reference signals used for radio link monitoring (RLM). Also, the first alterative incorporates UL/DL channel correspondence as another input to capture interconnected link conditions. The AI/ML model can evaluate these inputs over both current and historical measurement windows to determine an RLF prediction for the future, such as, for example, 90% chance of RLF failure probability score mapped to a future timeframe T5 or an 80% chance of RLF failure probability score mapped to a future timeframe T6. Based on the decreased RLF at T6, handover may not be performed.

As illustrated in FIG. 12B, in diagram 1210B, the second alterative is depicted, where the AI/ML model supplements the inputs with additional radio link metrics including consecutive HARQ transmission timeouts (e.g., HARQ consecutive Discontinuous Transmission (DTX) number) and measured reference signal strengths (BFD status). Each input may also include time of inputs such as, for example, t1, t2, t3, etc. By fusing an expanded set of correlated RLF inputs, even greater precision and foresight into impending radio link failures can be achieved through data-driven machine learning analytics. Similarly, the second alterative can also incorporate UL/DL channel correspondence as another input to capture interconnected link conditions. The AI/ML model can evaluate these inputs over both current and historical measurement windows to determine an RLF prediction, such as, for example, 90% chance of RLF failure probability score mapped to a future timeframe T5 or an 80% chance of RLF failure probability score mapped to a future timeframe T6.

In one embodiment, the alternative AI/ML RLF prediction operation can include additional metrics and aspects for the AI/ML models for radio link failure (RLF) prediction. The supplemental metrics that can be incorporated as inputs to the artificial intelligence/machine learning (AI/ML) model for RLF prediction include: 1) HARQ DTX log: Hybrid automatic repeat request (HARQ) discontinuous transmission (DTX) detects transmission failures due to the receiver failing to acknowledge sent packets. Consecutive DTX events indicate repeated transmission issues, 2) BFD status: Beam failure detection (BFD) checks indicates the UE finding and switching to a new beam, implying channel quality degradation, 3) DL and UL throughput: Downlink (DL) and uplink (UL) data flow rates likewise quantify growing radio link impairments, 4) L1 SSB/CSI-RS measurement (RSRP/RSRQ): Layer 1 reference signal received power (RSRP) and quality (RSRQ) for synchronization and channel state estimation provide additional over-the-air signal metrics, 5) L3 intra-frequency measurement: Layer 3 neighboring cell measurements offer indicators of comparative link conditions.

Additionally, the RLF prediction can include the RLF prediction and confidence score. The AI based RLF prediction model can be performed in different modes such as, for example, where a network is configured for periodic scheduling, where an event configured by the network is triggers such as, for example, event 1 (e.g., the T310 RLF timer, event 2 (e.g., when the RACH number is greater than a threshold), and/or event 3 (e.g., when the RLC retransmission number is greater than a threshold). Also, the AI based RLF prediction model can be performed and provide periodic reporting when network stipulated trigger events occur. The predicted RLF report can be transmitted to a primary cell (PCell) or primary cell of a master or secondary cell group (SpCell) over Radio Resource Control (RRC) signaling on primary and/or provide reporting leveraging a secondary cell or SCell using Medium Access Control (MAC) control elements or RRC signaling to increase reliability.

As described herein, the AI based model can be monitored by a UE and/or the base station. For base station-based monitoring, the specific performance monitoring metrics evaluated can be determined per base station implementation. The UE can be configured to provide supplemental information to assist base station tracking such as time stamps of predictions and actual measurements for temporal alignment, spatial orientation details, positional differences compared to predicted movements.

When model monitoring is UE-based, the performance monitoring metrics can include confidence levels of the predictions, prediction accuracy metrics, or error values between predicted and actual block error rate (BLER) measurements—for instance mean squared error (MSE) between projected and observed BLER. To obtain actual BLER measurements, the UE performs both inference and direct measurement for a small set of reference signals. Alternatively, the performance monitoring metrics can include an evaluation of overall system performance indicators such as, for example, changes in throughput, a number of radio link failures (RLF) declared within a configured time duration, and other defined.

Also, as described herein, the UE can be configured to perform model switching or updating based on either UE initiated triggers or network (NW) initiated signaling.

In one embodiment, for UE initiated switching or updating, the UE is configured with metric thresholds and corresponding model fallback behaviors by the base station (base station). For example, the UE may monitor the mean squared error (MSE) between block error rate (BLER) predictions and actual measurements, with a threshold of 0.01 specified by the network. If the MSE exceeds 0.01, the pre-defined behavior is for the UE to switch back to conventional BLER measurement procedures without relying on the machine learning model. Additionally, if the network configures different models associated with different combinations of reference signals for radio link monitoring (RLM-RSs), the UE can autonomously switch to the appropriate model matching the current RLM-RS pattern signaled via downlink control information (DCI), media access control (MAC) control elements, or radio resource control (RRC) updating.

For network-initiated model switching, the UE can report AI model monitoring metrics through means such as unified air interface (UAI) signaling or MAC-CEs and awaits explicit model lifecycle management (LCM) commands from the base station. The UE may also use standard procedures based on network indication regardless of monitoring outcomes. To aid reliable monitoring and adaptation, the base station can further provide supplemental assistance information to the UE. The assistance information can include, for example, nearby base station deployment geometry maps, long-term temporal correlation statistics, and/or long-term statistics or inter-beam correlation (e.g., quasi-co-location (QCL) type D reference).

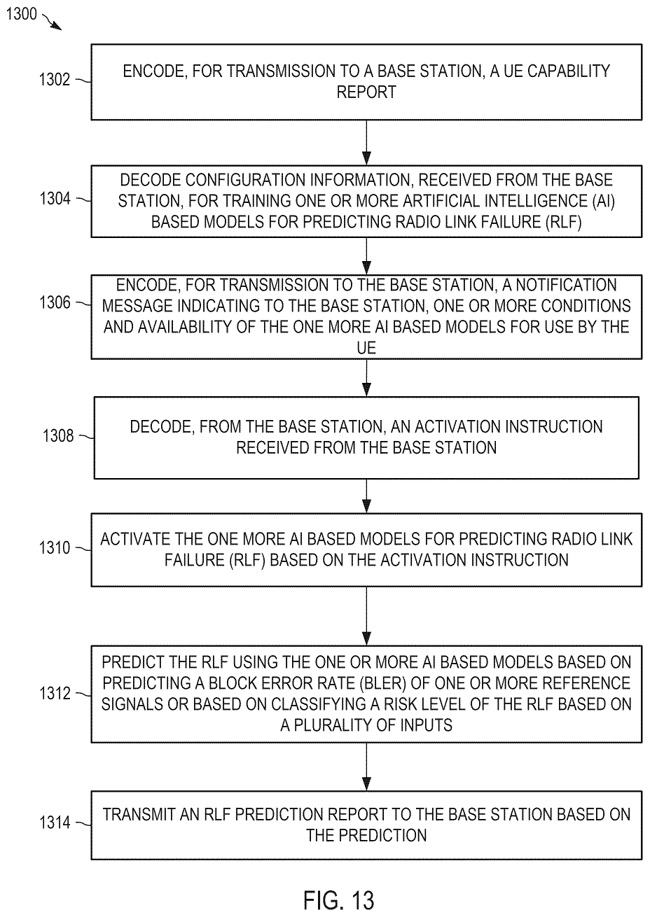

### FIG. 13: Flow Chart for a Method of Providing Artificial Intelligence (AI) Based Radio Link Failure (RLF) Prediction at a UE

FIG. 13 illustrates an example flow chart of a method of user equipment (UE) side performance monitoring for providing artificial intelligence (AI) based radio link failure (RLF) prediction, at a UE, according to some embodiments.

The method shown in FIG. 13 may be used in conjunction with any of the systems, methods, or devices illustrated in the Figures, among other devices. In various embodiments, some of the method elements shown may be performed concurrently, in a different order than shown, or may be omitted. Additional method elements may also be performed as desired.

In accordance with an embodiment, a method 1300 for providing artificial intelligence (AI) based RLF prediction, encode, for transmission to a base station (base station), a UE capability report, as shown in block 1302.

The method 1300 further comprises decoding configuration information, received from the base station, for training one or more artificial intelligence (AI) based models for predicting radio link failure (RLF), as shown in block 1304. The method 1300 further comprises encoding, for transmission to the base station, a notification message indicating to the base station, one or more conditions and availability of the one more AI based models for use by the UE, as shown in block 1306.

The method 1300 further comprises decoding, from the base station, an activation instruction received from the base station, as shown in block 1308. The method 1300 further comprises activating the one more AI based models for predicting radio link failure (RLF) based on the activation instruction, as shown in block 1310.

The method 1300 further comprises predicting the RLF using the one or more AI based models based on predicting a block error rate (BLER) of one or more reference signals or based on classifying a risk level of the RLF based on a plurality of inputs, as shown in block 1312. The method 1300 further comprises transmitting an RLF prediction report to the base station based on the prediction, as in block 1314.

The method 1300 further comprises collecting data at the UE for training the one or more AI based models. The method 1300 further comprises training the one or more AI based models using data collected at the UE. The method 1300 further comprises monitoring performance of the one or more AI based models activated at the UE for predicting the RLF. The method 1300 further comprises deactivating and/or switch the one or more AI based models based on the performance monitoring.

In some embodiments, the UE capability report indicates support for temporal prediction of block error rate (BLER) of a reference signal for radio link monitoring (RLM), a maximum number of history samples and predicted samples for BLER prediction, a maximum number of predicted samples, and a maximum number of parallel predictions. The configuration information may include an indication of each type of the one more AI based models, a prediction window length for BLER prediction, and a number of parallel predictions.

In some embodiments the notification message indicates those of the one or more AI based models that are available for use at the UE and corresponding model applicability conditions.

The method 1300 further comprises decode, from the base station, the activation instruction via downlink control information, medium access control-control element, or radio resource control signaling. The method 1300 further comprises predicting the BLER for radio link monitoring reference signals (RLM-RS) for radio link monitoring or a transparent control information (TCI) state of an activated physical downlink control channel (PDCCH) based on a plurality of previous BLER measurements. In some embodiments, the one or more of the pluralities of previous BLER measurements and predicted BLER measurements are configured by the base station.

The method 1300 further comprises predicting the BLER based on one or more previous BLER measurements of one or more different reference signals. The method 1300 further comprises decoding assistance information, received from the base station, comprising a long-term beam correlation between first and second reference signals.

The method 1300 further comprises generating a confidence level associated with each predicted BLER. The method 1300 further comprises performing BLER prediction of the RLF continuously, periodically, or based on an event trigger configured by the network.

The method 1300 further comprises identifying the event trigger based upon expiration of a timer or a number of out-of-sync (OOS) indications received from a lower layer of the UE.

In some embodiments, the RLF prediction report indicates a BLER prediction error between predicted BLER measurements and actual BLER measurements.

The method 1300 further comprises periodically reporting the RLF prediction to a primary cell via radio resource control signaling. The method 1300 further comprises encoding, the RLF prediction report, for transmission to a secondary cell via a medium access control control element (MAC-CE) or radio resource control (RRC) signaling when a first event is triggered, wherein the first event comprises a reference signal measurement exceeding a predetermined threshold.

The method 1300 further comprises encoding, the RLF prediction report, for transmission to a secondary cell via a medium access control control element (MAC-CE) or radio resource control (RRC) signaling when a second event is triggered, where the second event comprises expiration of a timer. The method 1300 further comprises transmitting a scheduling request to the base station when the second event is triggered.

The method 1300 further comprises periodically reporting the RLF prediction report to a secondary cell via medium access control control element (MAC-CE) or radio resource control (RRC) signaling when a second event is triggered, where the second event comprises expiry of a timer. The method 1300 further comprises encoding, the RLF prediction report, for transmission to the base station to enable the base station to determine whether to send a handover command to back the UE based on the RLF prediction indicating a risk of radio link failure.

The method 1300 further comprises decoding, the handover command, received via a secondary cell based on the RLF prediction indicating a radio link quality level below a quality threshold level on a primary cell. The method 1300 further comprises decoding, a handover command, from the base station based on the RLF prediction indicating the radio link quality level is above a quality threshold level.

The method 1300 further comprises predicting the RLF using the one or more AI based models with one or more of the plurality of inputs, wherein the plurality of inputs is: a number of random access channel attempts; a number of radio link control re-transmissions; measurements of reference signals configured for radio link monitoring; and an uplink-downlink correspondence metric.

The method 1300 further comprises predicting the RLF using the one or more AI based models with one or more of the plurality of inputs: a number of random-access channel attempts; a number of radio link control retransmissions; measurements of reference signals configured for radio link monitoring; a number of consecutive hybrid automatic repeat discontinuous transmission (HARQ DTX) events; and measured reference signal received power of non-radio link monitoring reference signals.

The method 1300 further comprises predicting the RLF periodically based on a periodicity configuration received from the network.

The method 1300 further comprises monitoring performance of the one or more AI based models based on a prediction confidence level, a prediction accuracy, BLER measurements, a system performance metric, or a combination thereof. The method 1300 further comprises autonomously switching between the one or more AI based models based on a performance threshold or a change in reference signals.

In some embodiments, an apparatus is disclosed that is configured to cause a user equipment (UE) to perform any of the operations of the method 1300.

In some embodiments, a computer program product is disclosed, comprising computer instructions which, when executed by one or more processors, perform any of the operations described with respect to the method 1300.

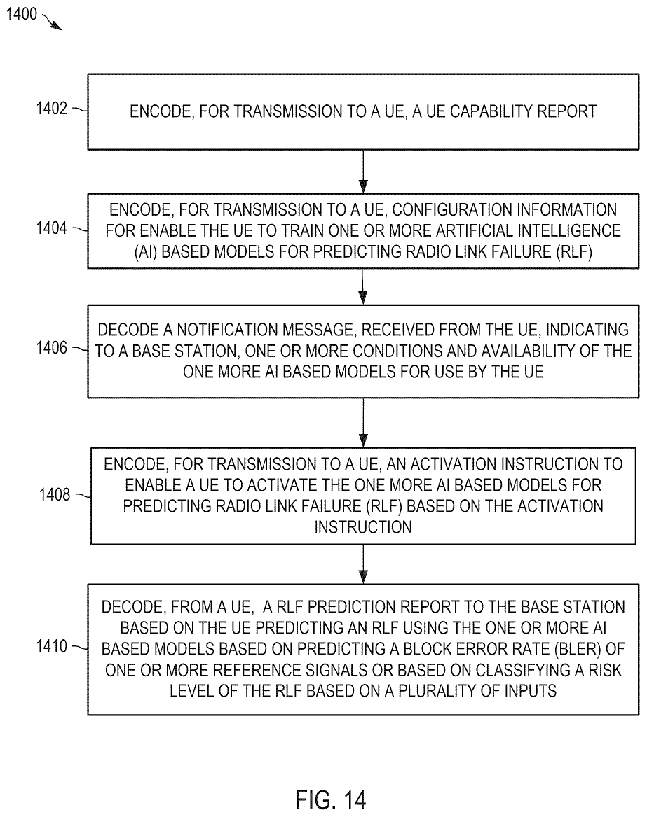

### FIG. 14: Flow Chart for a Method of Assisting With Artificial Intelligence (AI) Based Radio Link Failure (RLF) Prediction for User Equipment (UE) at a Base Station

FIG. 14 illustrates a flow chart of an example of a method for assisting with artificial intelligence (AI) based radio link failure (RLF) prediction for user equipment (UE), at base station (base station), at a base station (e.g., a base station), according to some embodiments. The method shown in FIG. 14 may be used in conjunction with any of the systems, methods, or devices illustrated in the Figures, among other devices. In various embodiments, some of the method elements shown may be performed concurrently, in a different order than shown, or may be omitted. Additional method elements may also be performed as desired.

In accordance with an embodiment, a method 1400 for assisting with artificial intelligence (AI) based RLF prediction, encode, for transmission to a UE, a UE capability report, as shown in block 1402.

The method 1400 further comprises encoding, for transmission to a UE, configuration information for enable the UE to train one or more artificial intelligence (AI) based models for predicting radio link failure (RLF), as shown in block 1404. The method 1400 further comprises decoding a notification message, received from the UE, indicating to the base station, one or more conditions and availability of the one more AI based models for use by the UE, as shown in block 1406.

The method 1400 further comprises encoding, for transmission to a UE, an activation instruction to enable a UE to activate the one more AI based models for predicting radio link failure (RLF) based on the activation instruction, as in block 1408.

The method 1400 further comprises decoding, from a UE, a RLF prediction report to the base station based on the UE predicting an RLF using the one or more AI based models based on predicting a block error rate (BLER) of one or more reference signals or based on classifying a risk level of the RLF based on a plurality of inputs, as in block 1410.

In some embodiments, the UE capability report indicates support for temporal prediction of block error rate (BLER) of a reference signal for radio link monitoring (RLM), a maximum number of history samples and predicted samples for BLER prediction, a maximum number of predicted samples, and a maximum number of parallel predictions. In other embodiments, the configuration information comprises an indication of each type of the one more AI based models, a prediction window length for BLER prediction, and a number of parallel predictions.

In some embodiments, the notification message indicates those of the one or more AI based models that are available for use at the UE and corresponding model applicability conditions. In some embodiments, the RLF prediction report indicates a BLER prediction error between predicted BLER measurements and actual BLER measurements.

The method 1400 further comprises encoding, for transmission to the UE, assistance information comprising a long-term beam correlation between first and second reference signals. The method 1400 further decoding, the RLF prediction report, receive from the UE, to enable the base station to determine whether to send a handover command to back the UE based on the RLF prediction indicating a risk of the RLF.

In some embodiments, an apparatus is configured to cause a base station (base station) to perform operations of the method 1400. The apparatus of the base station can comprise one or more processors, coupled to a memory, configured to perform any of the operations of the method 1400.

In some embodiments, the illustrated embodiments provide for a user equipment (UE) comprising one or more processors coupled to a memory and configured to encode, for transmission to a base station, a UE capability report; decode configuration information, received from the base station, for training one or more artificial intelligence (AI) based models for predicting radio link failure (RLF); encode, for transmission to the base station, a notification message indicating to the base station, one or more conditions and availability of the one more AI based models for use by the UE; decode, from the base station, an activation instruction; activate the one more AI based models for predicting radio link failure (RLF) based on the activation instruction; predict the RLF using the one or more AI based models based on predicting a block error rate (BLER) of one or more reference signals or based on classifying a risk level of the RLF based on a plurality of inputs; and transmit a RLF prediction report to the base station based on the prediction.

In some embodiments, the one or more processors are further configured to collect data at the UE for training the one or more AI based models. In some embodiments, the one or more processors are further configured to train the one or more AI based models using data collected at the UE. In some embodiments, the one or more processors are further configured to monitor performance of the one or more AI based models activated at the UE for predicting the RLF. In some embodiments, the one or more processors are further configured to deactivate or switch the one or more AI based models based on the performance monitoring.

In some example, the UE capability report indicates support for temporal prediction of block error rate (BLER) of a reference signal for radio link monitoring (RLM), a maximum number of history samples and predicted samples for BLER prediction, a maximum number of predicted samples, and a maximum number of parallel predictions. The configuration information can include an indication of each type of the one more AI based models, a prediction window length for BLER prediction, and a number of parallel predictions. The notification message can indicate those of the one or more AI based models that are available for use at the UE and corresponding model applicability conditions.

In some embodiments, the one or more processors are further configured to decode, from the base station, the activation instruction via downlink control information, medium access control-control element, or radio resource control signaling. In some embodiments, the one or more processors are further configured to predict the BLER for radio link monitoring reference signals (RLM-RS) for radio link monitoring or a transparent control information (TCI) state of an activated physical downlink control channel (PDCCH) based on a plurality of previous BLER measurements.

In some embodiments, the one or more of the plurality of previous BLER measurements and predicted BLER measurements are configured by the base station. In some embodiments, the one or more processors are further configured to predict the BLER based on one or more previous BLER measurements of one or more different reference signals.

In some embodiments, the one or more processors are further configured to decode assistance information, received from the base station, comprising a long-term beam correlation between first and second reference signals.

In some embodiments, the one or more processors are further configured to generate a confidence level associated with each predicted BLER.

In some embodiments, the one or more processors are further configured to perform BLER prediction of the RLF continuously, periodically, or based on an event trigger configured by a network.

In some embodiments, the one or more processors are further configured to identify the event trigger based upon expiration of a timer or a number of out-of-sync (OOS) indications received from a lower layer of the UE.

In some examples, the RLF prediction report indicates a BLER prediction error between predicted BLER measurements and actual BLER measurements.

In some embodiments, the one or more processors are further configured to periodically report the RLF prediction to a primary cell via radio resource control signaling. In some embodiments, the one or more processors are further configured to encode, the RLF prediction report, for transmission to a secondary cell via a medium access control control element (MAC-CE) or radio resource control (RRC) signaling when a first event is triggered, wherein the first event comprises a reference signal measurement exceeding a predetermined threshold.

In some embodiments, the one or more processors are further configured to encode, the RLF prediction report, for transmission to a secondary cell via a medium access control control element (MAC-CE) or radio resource control (RRC) signaling when a second event is triggered, wherein the second event comprises expiration of a timer.

In some embodiments, the one or more processors are further configured to transmit a scheduling request to the base station when the second event is triggered. In some embodiments, the one or more processors are further configured to periodically report the RLF prediction report to a secondary cell via medium access control control element (MAC-CE) or radio resource control (RRC) signaling when a second event is triggered, wherein the second event comprises expiry of a timer. In some embodiments, the one or more processors are further configured to encode, the RLF prediction report, for transmission to the base station to enable the base station to determine whether to send a handover command to back the UE based on the RLF prediction indicating a risk of radio link failure.

In some embodiments, the one or more processors are further configured to decode, the handover command, received via a secondary cell based on the RLF prediction indicating a radio link quality level below a quality threshold level on a primary cell. In some embodiments, the one or more processors are further configured to decode, a handover command, from the base station based on the RLF prediction indicating the radio link quality level is above a quality threshold level.

In some embodiments, the one or more processors are further configured to predict the RLF using the one or more AI based models with one or more of the plurality of inputs, wherein the plurality of inputs are: a number of random access channel attempts; a number of radio link control re-transmissions; measurements of reference signals configured for radio link monitoring; and an uplink-downlink correspondence metric.

In some embodiments, the one or more processors are further configured to predict the RLF using the one or more AI based models with one or more of the plurality of inputs: a number of random access channel attempts; a number of radio link control retransmissions; measurements of reference signals configured for radio link monitoring; a number of consecutive hybrid automatic repeat discontinuous transmission (HARQ DTX) events; and measured reference signal received power of non-radio link monitoring reference signals.

In some embodiments, the one or more processors are further configured to predict the RLF periodically based on a periodicity configuration received from a network.

In some embodiments, the one or more processors are configured to monitor performance of the one or more AI based models based on a prediction confidence level, a prediction accuracy, BLER measurements, a system performance metric, or a combination thereof.

In some embodiments, the one or more processors are configured to autonomously switch between the one or more AI based models based on a performance threshold or a change in reference signals.

In some embodiments, a computer program product is disclosed, comprising computer instructions which, when executed by one or more processors, perform any of the operations described with respect to the method 1400.

Embodiments of the present disclosure may be realized in any of various forms. For example, some embodiments may be realized as a computer-implemented method, a computer readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. A method of performing artificial intelligence (AI) based compression model performance monitoring by a user equipment (UE), the method comprising:
encoding, for transmission to a base station, a UE capability report;
decoding configuration information, received from the base station, for training one or more artificial intelligence (AI) based models for predicting radio link failure (RLF);
encoding, for transmission to the base station, a notification message indicating to the base station, one or more conditions and availability of the one more AI based models for use by the UE;
decoding, from the base station, an activation instruction;
activating the one more AI based models for predicting radio link failure (RLF) based on the activation instruction;
predicting the RLF using the one or more AI based models based on predicting a block error rate (BLER) of one or more reference signals or based on classifying a risk level of the RLF based on a plurality of inputs; and
transmitting an RLF prediction report to the base station based on the prediction.

2. The method of claim 1, further comprising:
collecting data at the UE for training the one or more AI based models; or
training the one or more AI based models using data collected at the UE; or
monitoring performance of the one or more AI based models activated at the UE for predicting the RLF; or
monitoring performance of the one or more AI based models based on a prediction confidence level, a prediction accuracy, BLER measurements, a system performance metric, or a combination thereof.

3. (canceled)

4. (canceled)

5. The method of claim 1, further comprising deactivating or switching the one or more AI based models based on the performance monitoring.

6. The method of claim 1, wherein the UE capability report indicates support for temporal prediction of block error rate (BLER) of a reference signal for radio link monitoring (RLM), a maximum number of history samples and predicted samples for BLER prediction, a maximum number of predicted samples, and a maximum number of parallel predictions.

7. The method of claim 1, wherein the configuration information comprises an indication of each type of the one more AI based models, a prediction window length for BLER prediction, and a number of parallel predictions.

8. The method of claim 1, wherein the notification message indicates those of the one or more AI based models that are available for use at the UE and corresponding model applicability conditions.

9. The method of claim 1, further comprising decoding, from the base station, the activation instruction via downlink control information, medium access control-control element, or radio resource control signaling.

10. The method of claim 1, further comprising:
predicting the BLER for radio link monitoring reference signals (RLM-RS) for radio link monitoring or a transparent control information (TCI) state of an activated physical downlink control channel (PDCCH) based on a plurality of previous BLER measurements; or
predicting the BLER based on one or more previous BLER measurements of one or more different reference signals; or
performing BLER prediction of the RLF continuously, periodically, or based on an event trigger configured by a network; or
wherein one or more of the plurality of previous BLER measurements and predicted BLER measurements are configured by the base station; or
predicting the RLF periodically based on a periodicity configuration received from a network.

11. (canceled)

12. (canceled)

13. The method of claim 1, further comprising decoding assistance information, received from the base station, comprising a long-term beam correlation between first and second reference signals.

14. The method of claim 1, further comprising generating a confidence level associated with each predicted BLER.

15. (canceled)

16. The method of claim 10, further comprising identifying the event trigger based upon expiration of a timer or a number of out-of-sync (OOS) indications received from a lower layer of the UE.

17. The method of claim 1, further comprising periodically reporting the RLF prediction to a primary cell via radio resource control signaling wherein the RLF prediction report indicates a BLER prediction error between predicted BLER measurements and actual BLER measurements.

18. (canceled)

19. The method of claim 1, further comprising:
encoding, the RLF prediction report, for transmission to a secondary cell via a medium access control control element (MAC-CE) or radio resource control (RRC) signaling when a first event is triggered, wherein the first event comprises a reference signal measurement exceeding a predetermined threshold or
encoding, the RLF prediction report, for transmission to a secondary cell via a MAC-CE or RRC signaling when a second event is triggered, wherein the second event comprises expiration of a timer.

20. (canceled)

21. The method of claim 19, further comprising transmitting a scheduling request to the base station when the second event is triggered.

22. The method of claim 1, further comprising periodically reporting the RLF prediction report to a secondary cell via medium access control control element (MAC-CE) or radio resource control (RRC) signaling when a second event is triggered, wherein the second event comprises expiry of a timer.

23. The method of claim 1, further comprising encoding, the RLF prediction report, for transmission to the base station to enable the base station to determine whether to send a handover command to back the UE based on the RLF prediction indicating a risk of radio link failure.

24. The method of claim 23, further comprising:
decoding, the handover command, received via a secondary cell based on the RLF prediction indicating a radio link quality level below a quality threshold level on a primary cell; or
decoding, a handover command, from the base station based on the RLF prediction indicating the radio link quality level is above a quality threshold level.

25. (canceled)

26. The method of claim 1, further comprising predicting the RLF using the one or more AI based models with one or more of the plurality of inputs, wherein the plurality of inputs are:
a number of random access channel attempts;
a number of radio link control re-transmissions;
measurements of reference signals configured for radio link monitoring; and
an uplink-downlink correspondence metric or
a number of random access channel attempts;
a number of radio link control retransmissions;
measurements of reference signals configured for radio link monitoring;
a number of consecutive hybrid automatic repeat discontinuous transmission (HARQ DTX) events; and
measured reference signal received power of non-radio link monitoring reference signals.

27. (canceled)

28. (canceled)

29. (canceled)

30. The method of claim 1, further comprising autonomously switching between the one or more AI based models based on a performance threshold or a change in reference signals.

31. (canceled)

32. (canceled)

33. (canceled)

34. An apparatus of a base station comprising:
one or more processors, coupled to a memory, configured to:
decode a user equipment (UE) capability report received from a UE;
encode, for transmission to the UE, configuration information, for training one or more artificial intelligence (AI) based models for predicting radio link failure (RLF);
decode a notification message, received from the UE, indicating to the base station one or more conditions and availability of the one more AI based models for use by the UE;
encode, for transmission to the UE, an activation instruction to indicated to the UE to activate the one more AI based models for predicting radio link failure (RLF) based on the activation instruction and predicting the RLF using the one or more AI based models based on predicting a block error rate (BLER) of one or more reference signals or based on classifying a risk level of the RLF based on a plurality of inputs; and
decode, an RLF prediction report, received from the UE, based on the prediction.

35.-40. (canceled)
